(19) United States
(12) Patent Application Publication
(10) Pub. No.: US 2022/0379253 A1
(43) Pub. Date: Dec. 1, 2022

(54) TWO-WAY AIR INTAKE AND MULTI-WIND WHEEL COMBINED AIR PURIFIER

(71) Applicant: Guangdong Cinotex Environmental Sci-Tech Co. Ltd., Zhongshan City (CN)

(72) Inventor: Haiyang LU, Zhongshan City (CN)

(21) Appl. No.: 17/402,493

(22) Filed: Aug. 13, 2021

(30) Foreign Application Priority Data
May 31, 2021 (CN) 202121203203.2

(51) Int. Cl. B01D 46/00; B01D 46/10

(52) U.S. Cl. CPC B01D 46/0049; B01D 46/002; B01D 46/10; B01D 2273/30

(57) ABSTRACT

The invention discloses a two-way air-intake air purifier combined with multi-wind wheel, which includes at least two sets of air inlet grooves are provided an air guide component and at least one air outlet grooves, when the motor fan works, it can drive the air to enter from the air inlet groove, divert the air through the air guide assembly, and make the air flow out of the air outlet groove, by having at least two sets of air inlet grooves and air outlet grooves on the second cover on the left and right sides, the effect of double air-inlet and double air-outlet is realized.

### FIELD OF THE INVENTION

The invention particularly relates to a two-way air-intake multi-wind wheel combined air purifier.

### BACKGROUND OF THE INVENTION

Air purifier refers to a purification device that can absorb, decompose or transform various air pollutants generally including PM2.5, dust, allergens, etc. It can effectively improve air cleanliness and is widely used in ordinary households and industries.

However, the existing air purifiers are unreasonable in design and can only achieve unilateral air inlet and unilateral air outlet, resulting in poor air circulation, which seriously affects filtration performance, especially after long-term use, unilateral air inlet and outlet may be blocked, etc. Circumstances seriously affect normal use and cannot meet daily needs.

Therefore, there is an urgent need for a two-way air inlet and multi-wheel combined air purifier to solve this problem.

### SUMMARY OF THE INVENTION

The purpose of this invention is to provide a two-way air inlet and multi-wheel combined air purifier.

A two-way air-intake and multi-wind wheel combined air purifier designed for this purpose includes a base. The front two sides of the base are respectively provided with first covers, and the left and right sides of the base are respectively provided with first covers. There is a second cover, and an upper cover is commonly connected above the first cover and the second cover;

At least two sets of air inlet grooves are provided on the first cover body, an air guide assembly is provided on the first cover body behind the air inlet groove, and at least one air outlet is provided on the second cover body Slot, the two air guide components on the same first cover are respectively connected to the left air outlet groove and the right air outlet groove, and a fan is provided in the air guide assembly;

The front side of the first cover is provided with a filter assembly.

Preferably, the front and rear two corresponding air guide components are attached to each other and connected with each other to form an air cavity, the fan is arranged in the air cavity, and the air cavity and the air outlet groove connect with each other.

Preferably, the air guiding component is an arc-shaped air guiding volute, the front and rear arc-shaped air guiding volutes are attached to each other to form an air cavity, the arc-shaped air guiding volute has an air outlet, and the air outlet is connected with the air outlet groove.

Preferably, the filter assembly includes a filter element, a accommodating cavity is provided on the front end of the first cover, the filter element is embedded in the accommodating cavity, and the front end of the first cover is also connected with The front cover has honeycomb holes evenly distributed on the front cover.

Preferably, the air inlet groove has six groups arranged in two columns, and the air outlet groove has three. The air guide assembly and the second cover on the left side of the air inlet groove are located in the left columns. The air outlet groove on the body is in communication, and the air guide assembly on the rear side of the air inlet groove in the right row is in communication with the air outlet groove on the second cover body on the right.

Preferably, grid bars are evenly distributed on the outer wall of the second cover.

Preferably, a cavity is also provided on the outer wall of the second cover.

The present invention has the advantages of simple and reasonable structure, good air circulation effect, and good filtering performance. Compared with the existing technique, the first cover is provided with at least two sets of air inlet grooves. The first cover on the side is provided with an air guide assembly, and at least one air outlet groove is opened on the second cover. The two air guide assemblies on the same first cover are respectively the same as the air outlet on the left side. The trough and the air outlet trough on the right side are connected to each other. A fan is arranged in the air guide assembly. The fan works to drive air into the air inlet and guide the air through the air guide assembly so that the air flows from the air outlet trough. For outflow, the present invention is provided with at least two sets of air inlet grooves and air outlet grooves on the second cover on the left and right sides to achieve the effect of double air inlet and double air outlet and ensure efficient air circulation.

### BRIEF DESCRIPTION OF THE DRAWINGS

FIG. 1 is one of the schematic cross-sectional structure diagrams of the present invention;

FIG. 2 is one of the schematic diagrams of the exploded structure of the present invention;

FIG. 3 is the second schematic diagram of the exploded structure of the present invention;

FIG. 4 is the third schematic diagram of the exploded structure of the present invention;

FIG. 5 is the second schematic diagram of the cross-sectional structure of the present invention;

FIG. 6 is a schematic diagram of the three-dimensional structure of the present invention;

FIG. 7 is a schematic diagram of the first embodiment of the fan layout in the present invention;

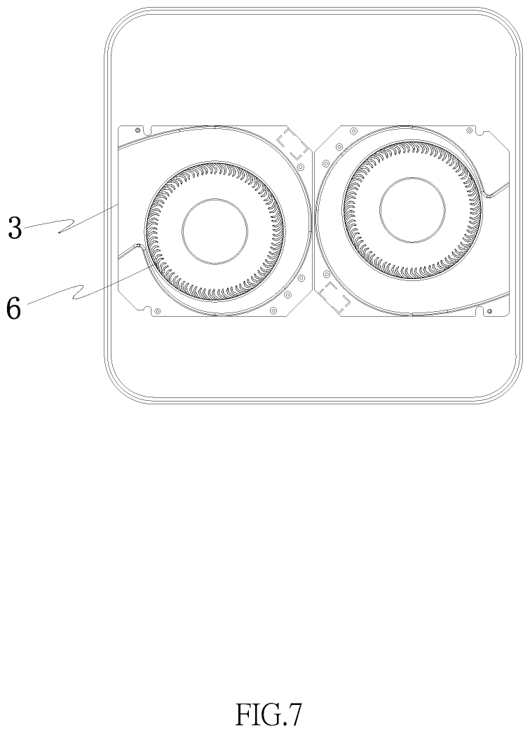

FIG. 8 is a schematic diagram of a second embodiment of the fan layout in the present invention;

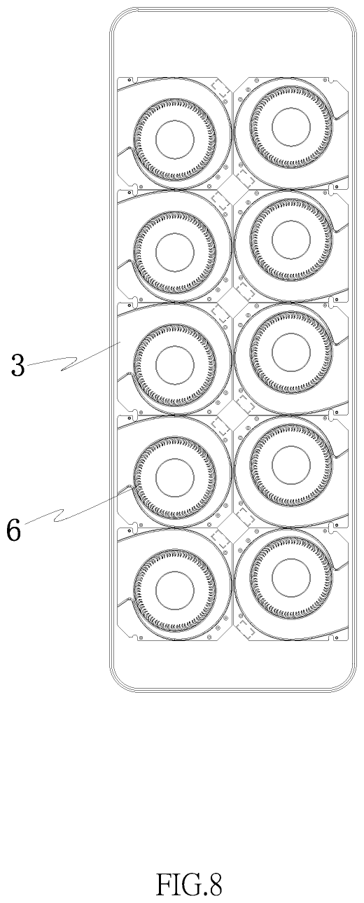

FIG. 9 is a schematic diagram of a third embodiment of the fan layout in the present invention;

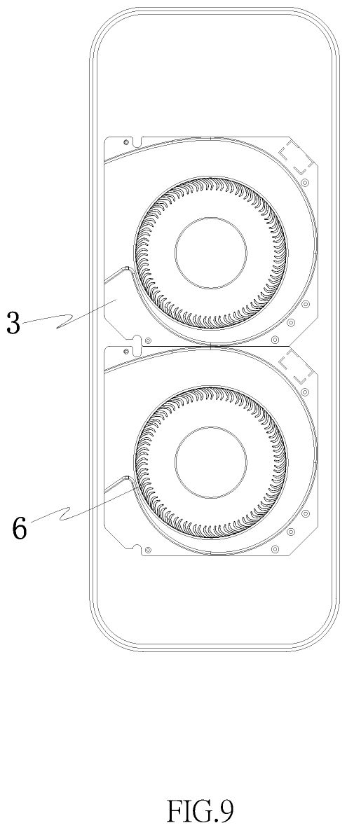

FIG. 10 is a schematic diagram of a fourth embodiment of the fan layout in the present invention;

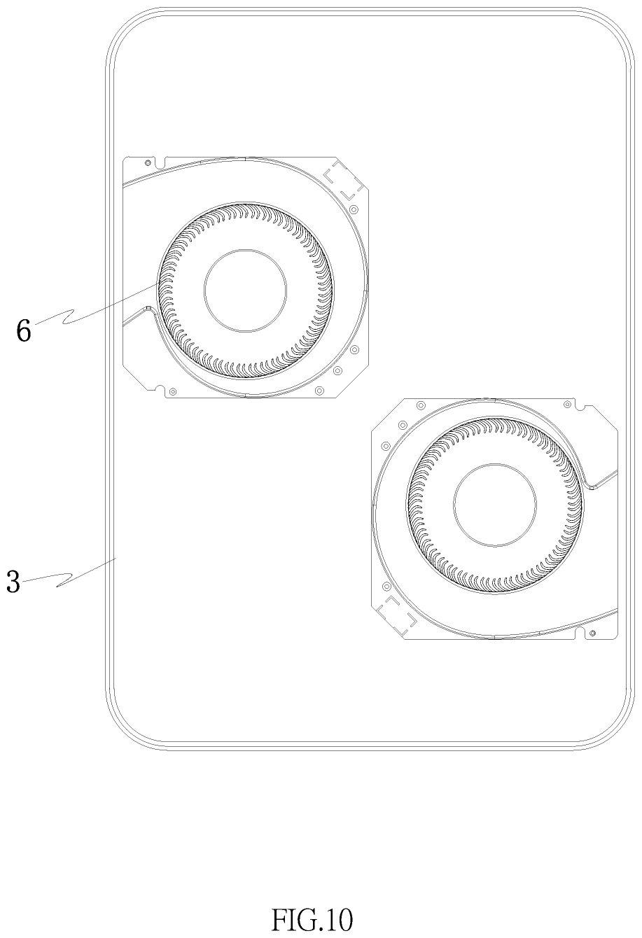

FIG. 11 is a schematic diagram of a fifth embodiment of the fan layout of the present invention;

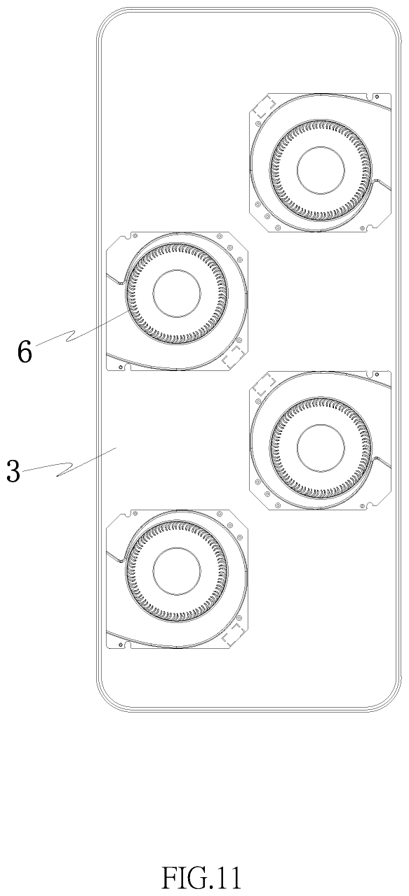

FIG. 12 is the fourth schematic diagram of the exploded structure of the present invention;

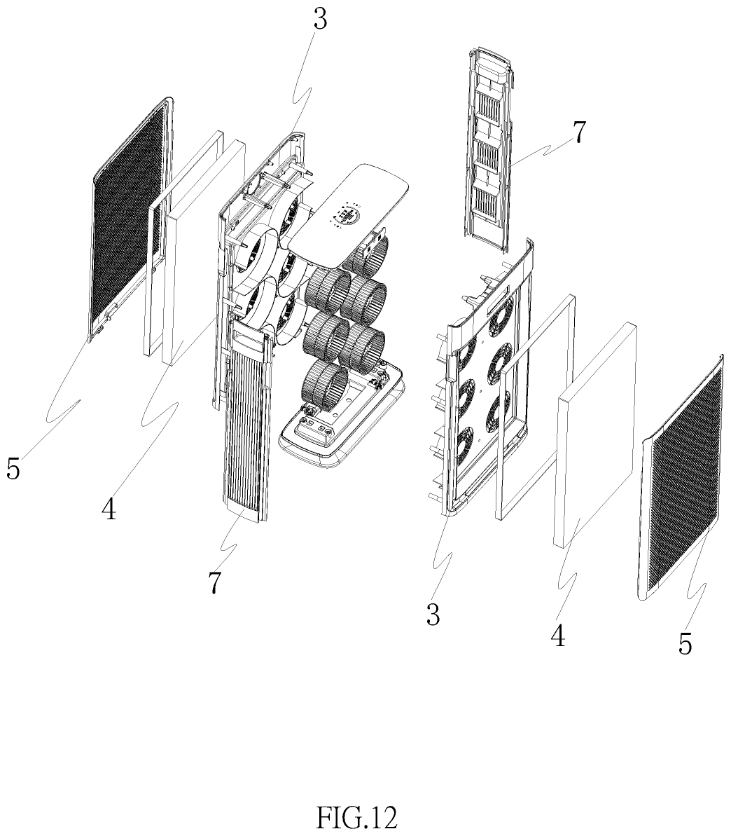

FIG. 13 is the fifth schematic diagram of the exploded structure of the present invention;

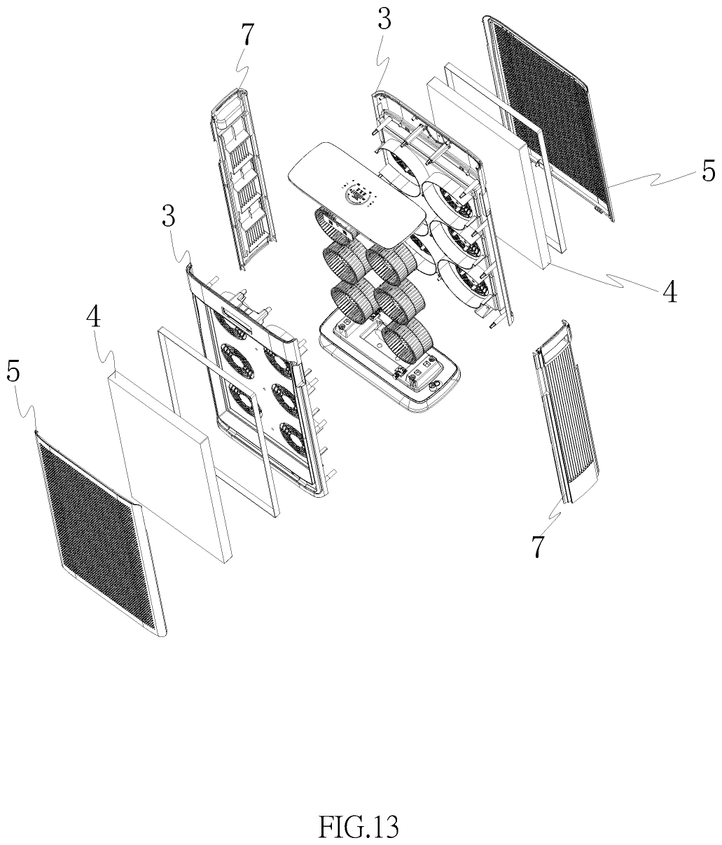

FIG. 14 is a schematic diagram of the planar structure of the present invention.

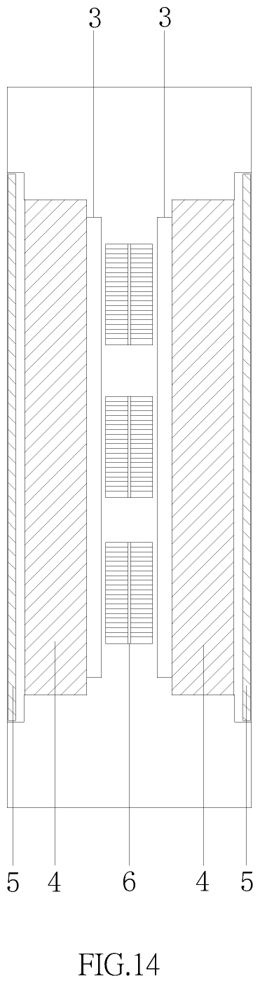

### DESCRIPTION OF THE PREFERRED EMBODIMENTS

The present invention will be further described below in conjunction with the drawings and embodiments.

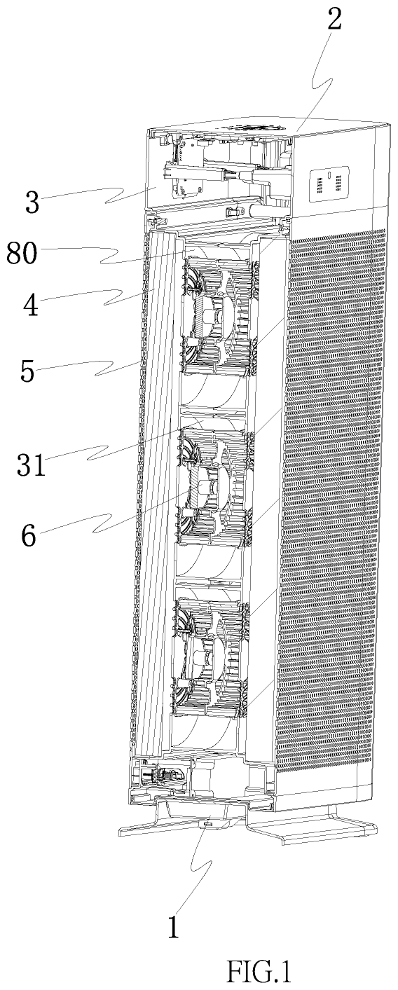

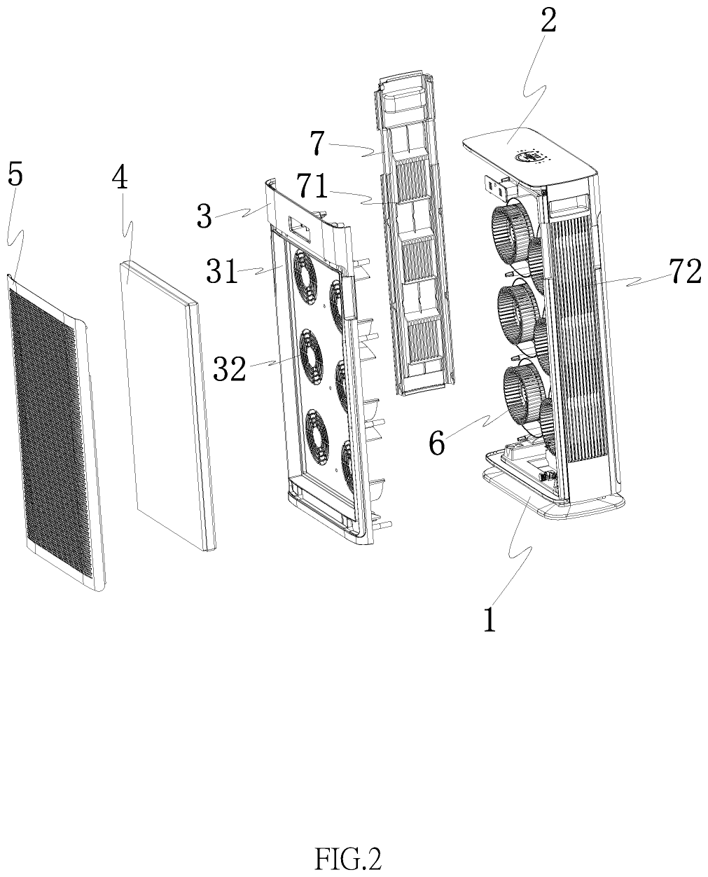

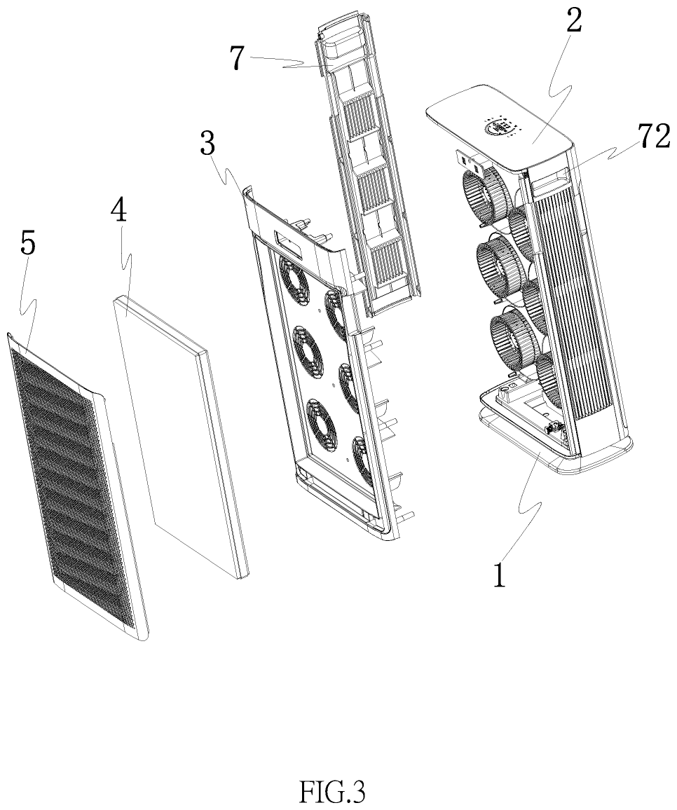

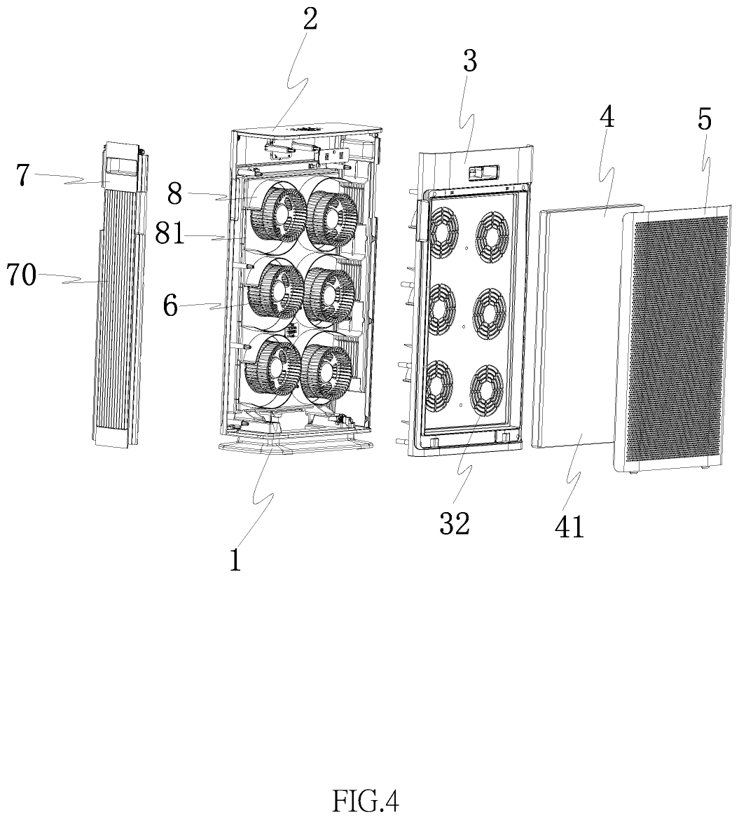

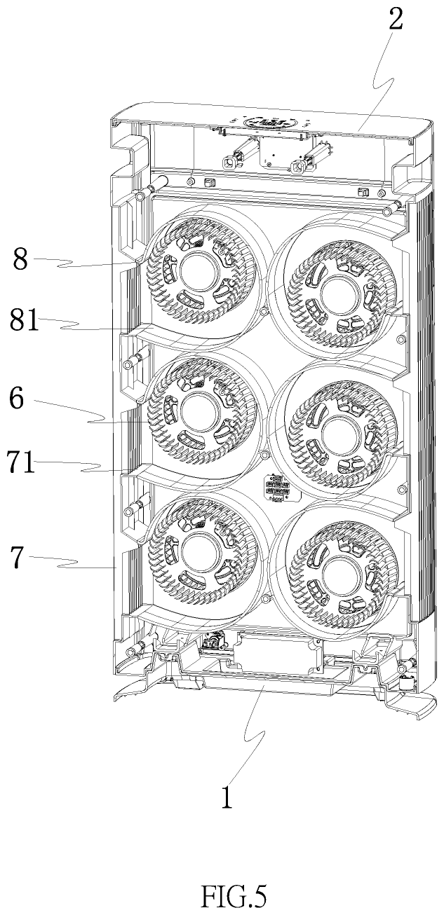

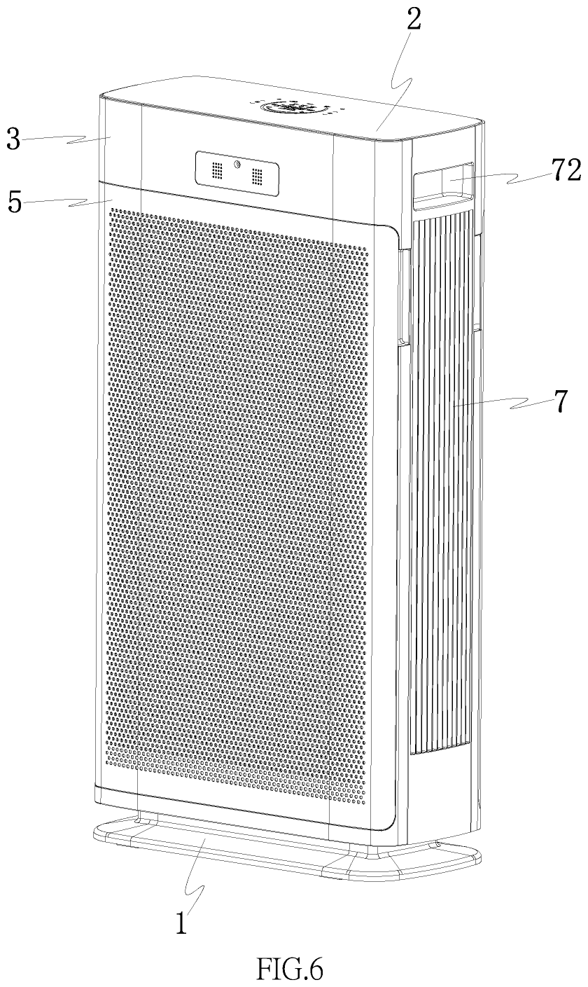

Referring to FIGS. 1 to 6, a two-way air-intake and multi-wind wheel combined air purifier includes a base 1, and both sides of the front side of the base 1 are respectively provided with a first cover 3, and the base 1 is provided on the left and right sides of the second cover 7, and an upper cover 2 is connected to the upper part of the first cover 3 and the second cover 7;

At least two sets of air inlet grooves 32 are provided on the first cover body 3, and the first cover body 3 on the rear side of the air inlet groove 32 is provided with an air guide assembly 8 on the second cover body 7. At least one air outlet groove 71 is provided, and the two air guide assemblies 8 on the same first cover 3 are connected to the left air outlet groove 71 and the right air outlet groove 71 respectively. A fan 6 is provided in the assembly 8;

The front side of the first cover 3 is provided with a filter assembly 4.

The fan works, it can drive the air from the front and back sides, after passing through the filter assembly 4, enter from the air inlet groove, pass the air guide assembly to divert the air, and make the air flow out of the air outlet groove. The present invention provides at least two inlets The air groove and the second cover on the left and right sides are provided with air outlet grooves to realize the effect of double air inlet and double air outlet, and ensure efficient air circulation.

The fan has a bracket, a motor mounted on the bracket, and a turbine connected with the motor shaft of the motor.

The fan can also be an existing fan, which will not be repeated here.

Referring to FIGS. 1 to 6, the front and rear two corresponding air guide components 8 are attached to each other and communicate with each other to form an air cavity 80. The fan 6 is arranged in the air cavity 80, the air cavity 80 and the air grooves 71 are connected to each other. The air guide components on the front and back of first covers are connected to form an air cavity, which can reduce the number of fans. The wind component diverts the air and makes the air flow to the air outlet groove.

Referring to FIGS. 1 to 6, the air guide assembly 8 is an arc-shaped air guide volute, the front and rear arc-shaped air guide volutes are attached to each other to form an air cavity 80, and the arc-shaped air guide volute has an air outlet 81. The air outlet 81 and the air outlet groove 71 are connected to each other.

Referring to FIGS. 1 to 6, the filter assembly 4 includes a filter element 41, the front end of the first cover 3 is provided with a receiving cavity 31, the filter element 41 is embedded in the receiving cavity 31, in the first cover A front cover 5 is also connected to the front end of a cover 3, the front cover 5 is uniformly distributed with honeycomb holes, the structure is simple, and the assembly is convenient. In the component 8, the structure is simple, and the air circulation effect is good, which meets the needs of use.

Referring to FIGS. 1 to 6, the air inlet grooves 32 have six groups arranged in two columns, respectively, the air outlet grooves 71 have three, and the air guide assembly 8 located behind the air inlet groove 32 in the left column is in communication with the air outlet groove 71 on the second cover body 7 on the left, and the air guide assembly 8 on the rear side of the air inlet groove 32 in the right column is in communication with the air outlet groove 71 on the second cover body 7 on the right.

Referring to FIGS. 1 to 6, the outer wall of the second cover 7 is also uniformly distributed with grille bars 70, which can not only hide the air outlet grooves but also guide the air to achieve the guiding of the air out.

Referring to FIGS. 1 to 6, a cavity 72 is also provided on the outer wall of the second cover 7.

In the description of the present invention, it should be understood that the terms “center”, “longitudinal”, “transverse”, “length”, “width”, “thickness”, “upper”, “lower”, “front”, “Back”, “Left”, “Right”, “Vertical”, “Horizontal”, “Top”, “Bottom”, “Inner”, “Outer”, “Clockwise”, “Counterclockwise” and other directions or the positional relationship is based on the position or positional relationship shown in the drawings, and is only for the convenience of describing the present invention and simplifying the description, and does not indicate or imply that the pointed device or element must have a specific orientation, be constructed and operated in a specific orientation, Therefore, it cannot be understood as a limitation of the present invention. The terms “first” and “second” are only used for descriptive purposes, and cannot be understood as indicating or implying relative importance or implicitly indicating the number of indicated technical features.

The basic principles and main features of the present invention and the advantages of the present invention have been shown and described above. Those skilled in the industry should understand that the present invention is not limited by the above-mentioned embodiments. The above-mentioned embodiments and descriptions only illustrate the principles of the present invention. Without changing the spirit and scope of the present invention, the present invention will have various changes and improvements, these changes and improvements all are within the scope of the claimed invention. The scope of protection claimed by the present invention is defined by the appended claims and their equivalents.

What is claimed is:

1. A two-way air intake and multi-wind wheel combined air purifier includes a base (1), and first covers (3) are respectively provided on both sides of the front side of the base (1), the left and right sides of the base (1) are respectively provided with a second cover (7), and an upper cover (2) is jointly connected above the first cover (3) and the second cover (7);
It is characterized in that: at least two sets of air inlet grooves (32) are provided on the first cover body (3), and the first cover body (3) on the rear side of the air inlet grooves (32) is provided with an air guide body (3). The component (8) is provided with at least one air outlet groove (71) on the second cover body (7), the two air guide components (8) on the same first cover (3) are respectively connected with the air outlet groove (71) on the left and the air outlet groove (71) on the right. There is a fan (6) inside of the above described air guide components (8); the front side of the first cover (3) is provided with a filter assembly (4).

2. The two-way air intake and multi-wind wheel combined air purifier as claimed in claim 1, characterized in that: the front and rear two corresponding air guide components (8) are attached to each other and communicate with each other to form an air cavity (80) The fan (6) is arranged in the air cavity (80), and the air cavity (80) and the air outlet groove (71) are in communication with each other.

3. The two-way air-intake multi-wind wheel combined air purifier as claimed in claim 2, characterized in that: the air guide assembly (8) is an arc-shaped air-guiding volute with two arc-shaped air-guiding volutes at the front and back. The shells are attached to each other to form an air cavity (80), the arc-shaped wind guide volute has an air outlet (81), and the air outlet (81) and the air outlet groove (71) are connected to each other.

4. The two-way air intake and multi-wind wheel combined air purifier as claimed in claim 1, characterized in that: the filter assembly (4) includes a filter element (41), and the first front end of the cover (3) is provided with a receiving cavity (31), the filter element (41) is embedded in the receiving cavity (31), and the front end of the first cover (3) is also connected with a front cover (5), and honeycomb holes are uniformly distributed on the front cover (5).

5. The two-way air intake and multi-wind wheel combined air purifier as claimed in claim 2, characterized in that: the filter assembly (4) includes a filter element (41), and the first front end of the cover (3) is provided with a receiving cavity (31), the filter element (41) is embedded in the receiving cavity (31), and the front end of the first cover (3) is also connected with a front cover (5), and honeycomb holes are uniformly-distributed on the front cover (5).

6. The two-way air intake and multi-wind wheel combined air purifier as claimed in claim 3, characterized in that: the filter assembly (4) includes a filter element (41), and the first front end of the cover (3) is provided with a receiving cavity (31), the filter element (41) is embedded in the receiving cavity (31), and the front end of the first cover (3) is also connected with a front cover (5), and honeycomb holes are uniformly distributed on the front cover (5).

7. The two-way air intake and multi-wind wheel combined air purifier as claimed in claim 1, characterized in that: the air inlet grooves (32) have six groups, which are arranged in two rows, respectively, There are three air outlet grooves (71), the air guide assembly (8) on the rear side of the air inlet groove (32) in the left column and the air outlet groove (71) on the second cover body (7) on the left side connected, the air guide assembly (8) located on the rear side of the air inlet groove (32) in the right column communicates with the air outlet groove (71) on the second cover body (7) on the right side.

8. The two-way air intake and multi-wind wheel combined air purifier as claimed in claim 2, characterized in that: the air inlet grooves (32) have six groups, which are arranged in two rows, respectively, There are three air outlet grooves (71), the air guide assembly (8) on the rear side of the air inlet groove (32) in the left column and the air outlet groove (71) on the second cover body (7) on the left side connected, the air guide assembly (8) located on the rear side of the air inlet groove (32) in the right column communicates with the air outlet groove (71) on the second cover body (7) on the right side.

9. The two-way air intake and multi-wind wheel combined air purifier as claimed in claim 3, characterized in that: the air inlet grooves (32) have six groups, which are arranged in two rows, respectively, There are three air outlet grooves (71), the air guide assembly (8) on the rear side of the air inlet groove (32) in the left column and the air outlet groove (71) on the second cover body (7) on the left side connected, the air guide assembly (8) located on the rear side of the air inlet groove (32) in the right column communicates with the air outlet groove (71) on the second cover body (7) on the right side.

10. The two-way air intake and multi-wind wheel combined air purifier as claimed in claim 1, characterized in that: the outer wall of the second cover (7) is also evenly distributed with grille bars (70).

11. The two-way air intake and multi-wind wheel combined air purifier as claimed in claim 2, characterized in that: the outer wall of the second cover (7) is also evenly distributed with grille bars (70).

12. The two-way air intake and multi-wind wheel combined air purifier as claimed in claim 3, characterized in that: the outer wall of the second cover (7) is also evenly distributed with grille bars (70).

13. The two-way air intake and multi-wind wheel combined air purifier as claimed in claim 1, characterized in that: the outer wall of the second cover (7) is also provided with a cavity (72).

14. The two-way air intake and multi-wind wheel combined air purifier as claimed in claim 2, characterized in that: the outer wall of the second cover (7) is also provided with a cavity (72).

15. The two-way air intake and multi-wind wheel combined air purifier as claimed in claim 3, characterized in that: the outer wall of the second cover (7) is also provided with a cavity (72).
